(19) United States
(12) Patent Application Publication
(10) Pub. No.: US 2025/0111284 A1
(43) Pub. Date: Apr. 3, 2025

(54) CONFIDENCE CALIBRATION FOR MACHINE LEARNING MODELS

(71) Applicant: DeepMind Technologies Limited, London (GB)

(72) Inventors: Urvashi Khandelwal, Los Altos, CA (US); Kelvin Gu, Redwood City, CA (US); Xiang Li, Stanford, CA (US)

(21) Appl. No.: 18/901,696

(22) Filed: Sep. 30, 2024

Related U.S. Application Data
(60) Provisional application No. 63/586,410, filed on Sep. 28, 2023.

(51) Int. Cl. G06N 20/00

(52) U.S. Cl. CPC G06N 20/00

(57) ABSTRACT

Methods, systems, and apparatus, including computer programs encoded on a computer storage medium, for confidence calibration of machine learning models. In one aspect, a method comprises receiving a plurality of query inputs to a target machine learning model that is configured to assign initial confidence scores to model outputs generated by the target machine learning model, processing the query inputs using a calibration model to generate precision data for the target machine learning model that specifies a precision curve mapping confidence thresholds to precisions, receiving a new input for the target machine learning model, processing the new input using the target machine learning model to generate a predicted model output for the new input and to assign an initial confidence score to the predicted model output, and generating a final output for the new input using the initial confidence score and the precision data for the target machine learning model.

### CROSS-REFERENCE TO RELATED APPLICATION

This application claims priority to U.S. Provisional Application No. 63/586,410, filed on Sep. 28, 2023. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that performs confidence calibration for machine learning models.

For example, the system can receive a plurality of query inputs to a target machine learning model. The target machine learning model has already been trained and is configured to process model inputs (i) to produce corresponding model outputs for the model inputs and (ii) to assign corresponding initial confidence scores to the produced outputs.

As used throughout this specification, a confidence score assigned by a machine learning model to a model output refers to a numerical value that characterizes a predicted probability (e.g., as predicted by the machine learning model) that the model output is a correct model output. An accuracy of the machine learning model for a particular confidence score (resp., for a particular range of confidence scores) refers to an expected probability that a model output is a correct model output given that the machine learning model assigns the model output the particular confidence score (resp., a confidence score within the particular range of confidence scores).

The system processes the query inputs using a calibration model to generate precision data for the target machine learning model. The precision data specifies a precision curve that maps confidence thresholds to precisions.

As used throughout this specification, a precision for a machine learning model at a given confidence threshold refers to an accuracy of the machine learning model (e.g., a fraction of correct model outputs generated by the machine learning model) for confidence scores greater than or equal to the given confidence threshold.

The system then receives a new input for the target machine learning model and processes the new input using the target machine learning model to generate a predicted model output for the new input and to assign an initial confidence score to the predicted model output.

The system can then generate a final output for the new input using the initial confidence score and the precision data for the target machine learning model. Generating a final output “using the precision data” should be understood as meaning generating the final output using one or more of the points on the precision curve or generating the final output using one or more quantities that have been pre-computed using the precision data.

Particular embodiments of the subject matter described in this specification can be implemented so as to realize one or more of the following advantages.

For many applications, obtaining estimates of an accuracy of predictions generated by a machine learning model is important for being able to reliably use the predictions generated by the machine learning model. In particular, obtaining accuracy estimates for machine learning models is vital for applications (e.g., health-care, autonomous driving, etc.) for which acting on incorrect predictions can lead to serious real-world consequences. Many machine learning techniques and architectures have therefore been developed to enable machine learning models to provide confidence estimates for their predictions.

Existing techniques have been developed to extract well-calibrated confidence estimates from machine learning models, e.g., language models (LMs), in which the model's confidence accurately reflects the probability that the answer is correct. However, while a model may be well-calibrated on average over some input distribution, the same model can be significantly miscalibrated within narrower slices of the full distribution. For example, the model can be overconfident (e.g., produce confidence estimates that overestimate the model's accuracy) for a first subset of the input distribution, which can balance out the model being underconfident (e.g., producing confidence estimates that underestimate the model's accuracy) for a second subset of the input distribution, resulting in the model appearing well-calibrated overall (e.g., averaging over the first and second subsets of the input distribution).

For some applications, it can be necessary to ensure that a machine learning model's confidence estimates are well-calibrated for multiple subsets (e.g., slices) of the model's overall input distribution. For example, when a machine learning model responds to queries from multiple different users, the calibration of the model for each individual user's distribution of input queries is as important as the overall calibration of the model as averaged over the distribution of every user query to the model.

This specification describes techniques for calibrating models on any given slice of a distribution, using just a few unlabeled samples from that slice. Specifically, the system uses a calibration model that approximates the precision-threshold curve for any given slice by using its few-shot samples to predict the target model's empirical precision at various confidence thresholds. This allows the system to, e.g., directly identify slice-specific thresholds above which the LM's predictions can be trusted and below which it should abstain. As another example, the precision curve can be mapped back to the classic calibration curve, which can guide adjusting the target model's confidence to achieve lower calibration error.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example confidence calibration system that can perform confidence calibration for a target machine learning model.

FIG. 2 illustrates training a calibration model for a target machine learning model.

FIG. 3 is a flow diagram of an example process for performing confidence calibration for a target machine learning model.

FIG. 4 is a flow diagram of an example process for training a calibration model for a target machine learning model.

FIG. 5A illustrates calibration curves for a target machine learning model that is miscalibrated on particular distributions of model inputs.

FIG. 5B illustrates experimental results from using a confidence calibration system to recalibrate a target machine learning model that is miscalibrated on particular distributions of model inputs.

Like reference numbers and designations in the various drawings indicate like elements.

### DETAILED DESCRIPTION

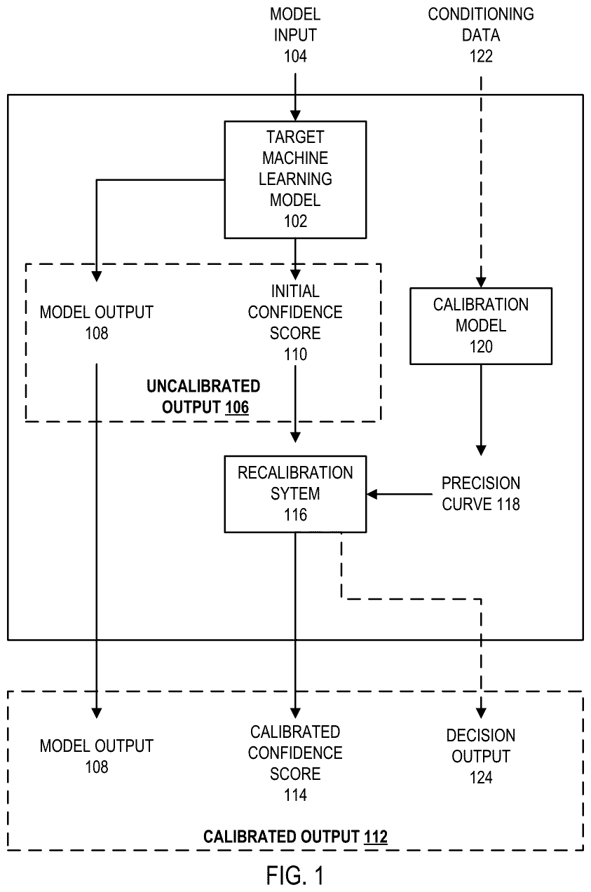

FIG. 1 shows an example confidence calibration system 100 that can perform confidence calibration for a target machine learning model 102. The confidence calibration system 100 is an example of a system implemented as computer programs on one or more computers in one or more locations in which the systems, components, and techniques described below are implemented.

The target machine learning model 102 can be configured to perform a prediction task and can process a model input 104 to generate an uncalibrated output 106 as part of performing the prediction task. In particular, the target machine learning model 102 can process the model input 102 to (i) produce a corresponding model output 108 for the model input 102 and (ii) assign an initial confidence score 110 to the model output 108 for the model input 102. The model output 108 can represent a prediction for the model input 104 for the prediction task and the confidence score 110 can characterize a predicted likelihood (e.g., as predicted by the target machine learning model 102) that the model output 108 is a correct prediction for the model input 104 for the prediction task. The target machine learning model can include the model output 108 and the confidence score 110 within the uncalibrated output 106.

The uncalibrated output 106 is uncalibrated in the sense that the confidence score 110 can differ from a ground truth accuracy (e.g., likelihood of producing a correct model output 108 for the model input 104) of the target machine learning model 102. For example, the target machine learning model 102 can be overconfident in the model output 108 and can generate a confidence score 110 that overestimates the likelihood that the model output 108 is correct. As another example, the target machine learning model 102 can be underconfident in the model output 108 and can generate a confidence score 110 that underestimates the likelihood that the model output 108 is correct.

The confidence calibration system 100 can calibrate the target machine learning model 102 by processing the uncalibrated output 106 to generate a calibrated output 112. The calibrated output 112 can include the model output 108 generated by the target machine learning model 102 and a calibrated confidence score 114 for the model output 108. The calibrated output 112 is calibrated in the sense that the calibrated confidence score 114 can more accurately predict the ground truth accuracy (e.g., the likelihood of producing a correct model output 108 for the model input 104) of the target machine learning model 102 compared to the confidence score 110.

The confidence calibration system 100 can include a recalibration system 116 configured to generate the calibrated confidence score 114 by processing the confidence score 110. In particular, the recalibration system 116 can generate the calibrated confidence score 114 by processing the confidence score 110 using a precision curve 118 for the target machine learning model 102. In general, the precision curve 118 maps confidence thresholds (e.g., thresholds on confidence scores 110 generated by the target machine learning model 102) to precisions for the confidence thresholds. A precision for a given confidence threshold refers is an accuracy of model outputs 108 (e.g., a fraction of correct model outputs 108) generated by the target machine learning model 102 that the model 102 assigns confidence scores 110 greater than or equal to the given confidence threshold. The recalibration system 116 can generate the calibrated confidence score 114 by mapping the confidence score 110 to a precision for the confidence score 110 and outputting the precision for the confidence score 110 as the calibrated confidence score 114.

The confidence calibration system 100 can generate the precision curve 118 using a calibration model 120 for the target machine learning model 102. The calibration model 120 can be a neural network having any of a variety of neural architectures for generating the precision curve 118. As another example, the calibration model 120 can be configured to receive conditioning data 122 for the calibration model and to generate the precision curve 118 for the target machine learning model 102 based on the conditioning data 122.

As a particular example, the calibration model 120 can be a token processing neural network configured to generate the precision curve 118 by processing conditioning data 122 that includes a sequence of input tokens for the calibration model 120. As an example, the calibration model 120 can be a language model configured to generate the precision curve 118 by processing an input sequence of tokens representing an input prompt for the calibration model 120.

The conditioning data 122 for the calibration model 120 can characterize a particular application distribution (e.g., “slice”) of model inputs and the calibration model 120 can generate the precision curve 118 for the target machine learning model 102 as applied to model inputs from the particular application distribution. As one example, the conditioning data 122 for the calibration model 120 can directly specify the particular application distribution, e.g., by including a label for the distribution, a description of the distribution, and so on. As another example, the network input for the calibration model 120 can include query model inputs sampled in accordance with the particular application distribution. As a further example, the model input 104 can be a prompt from a user, the particular application distribution can be a distribution of prompts from the user, and the calibration model 120 can generate the precision curve 118 by processing conditioning data 122 that includes query inputs received from the user prior to the model input 102.

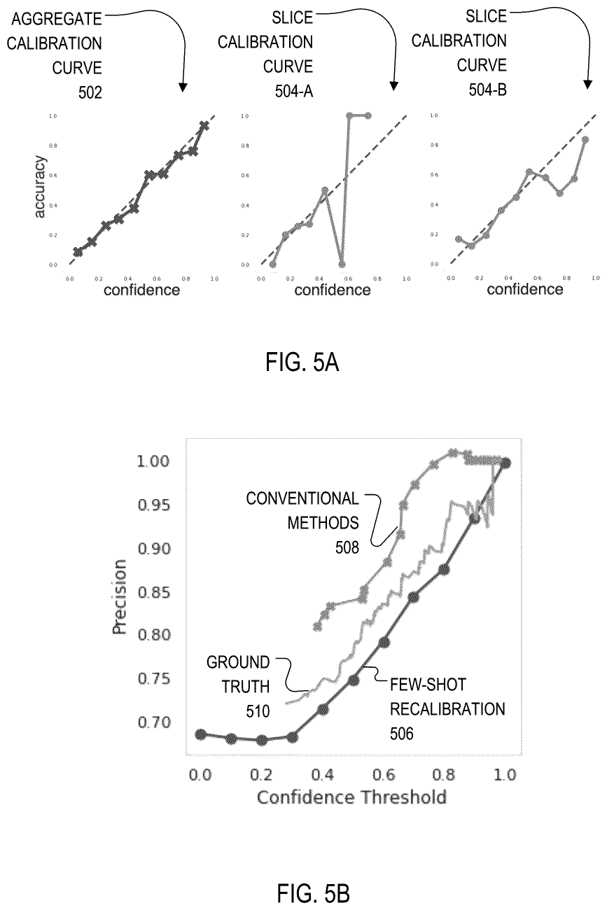

By processing conditioning data 122 that includes query inputs that characterize an application distribution (e.g., “slice”) of model inputs, the confidence calibration system 100 can perform few-shot recalibration of the target machine learning model 102. In particular, the confidence calibration system 100 can perform few-shot recalibration of the target machine learning model 102 for an application distribution using unlabeled model inputs (e.g., model inputs that do not specify an identity of the application distribution). For example, when the target machine learning model 102 processes input prompts received from a user, the confidence calibration system 100 can perform few-shot recalibration of the target machine learning model 102 for the user based on previously received prompts from the user. As illustrated in FIG. 5A and FIG. 5B, performing few-shot recalibration of the target machine learning model 102 using unlabeled inputs can improve the accuracy of predicted confidence scores when the target machine learning model 102 is miscalibrated for individual application distributions.

By performing few-shot recalibration of the target machine learning model 102, the system 100 can provide well-calibrated confidence estimates for the target machine learning model 102 each time the system 100 performs a processing task using the model 102. For example, when system 100 responds to queries from multiple different users, the system 100 can provide well-calibrated confidence estimates for each user.

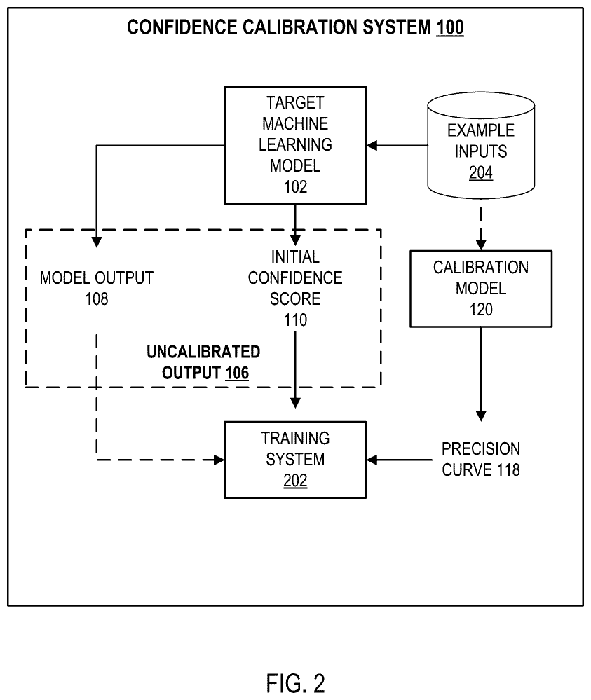

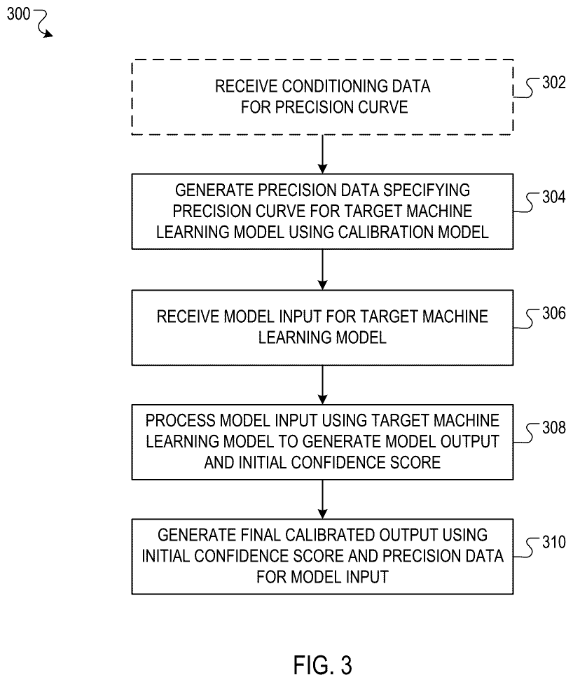

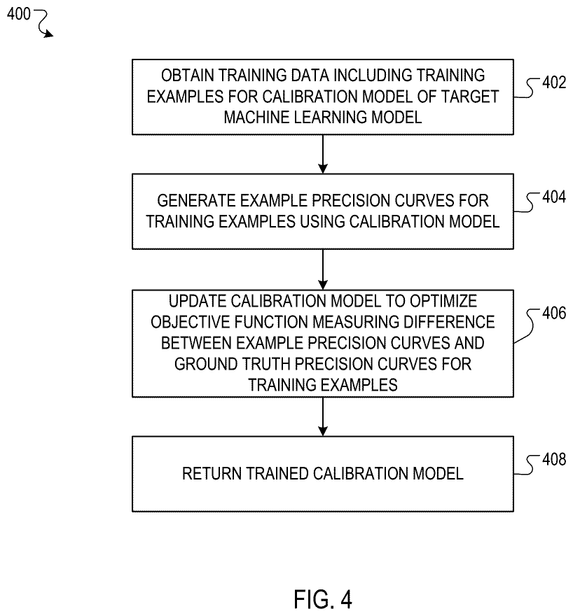

Training the calibration model 120 to generate precision curves 118 for the target machine learning model 102 is described in more detail below with reference to FIG. 2 and FIG. 4. Generating the precision curve 118 for the target machine learning model 102 is described in more detail below with reference to FIG. 3.

The model input 104 can include data for any of a variety of data modalities and the target machine learning model 102 can be any appropriate machine learning model configured to process the model input 104. The model input 104 can include data characterizing, e.g., numerical data, text data, image data, video data, audio data, and so on. The target machine learning model 102 can include, e.g., a support vector machine, a random forest model, a regression model, a neural network, and so on, configured to process the model input 104. In particular, the target machine learning model can include a neural network with any appropriate neural network architecture with processing layers (e.g., multi-layer perceptron layers, convolutional layers, recurrent layers, graph processing layers, attention layers, etc.) in any arrangement appropriate for processing the model input 104.

As a particular example, the model input 104 can include a sequence of input tokens and the target machine learning model 102 can be a token processing neural network. When the target machine learning model 102 is a token processing neural network, the model 102 can process the model input 104 and generate an output sequence of tokens as the model output 108. As an example, the model input 104 can be an input sequence of tokens representing an input prompt and the target machine learning model 102 can be a language model configured to generate the model output 108 by processing the model input 104.

The target machine learning model 102 can be configured to perform any of a variety of prediction tasks. For example, the target machine learning model 102 can be configured to perform a regression task (e.g., predicting one or more numerical values by processing the model input 104). As another example, the target machine learning model 102 can be configured to perform a classification task (e.g., predicting one or more categorical values by processing the model input 104). As another example, the target machine learning model 102 can be configured to perform a generation task (e.g., generating data as conditioned on the model input 104).

The target machine learning model 102 can be a neural network configured to process and perform prediction tasks specific to any of the data modalities included within the model input 104. For example, when the model input 104 includes text data, the target machine learning model 102 can include a language model neural network configured to perform a text processing task, such as text generation, text summarization, translation, text classification, and so on. As another example, when the model input 104 includes image (resp., video) data, the target machine learning model 102 can include a visual language model neural network configured to perform an image (resp. video) processing task, such as image (resp., video) generation, captioning, summarization, classification, and so on. As another example, when the model input 104 includes audio data, the target machine learning model 102 can be an audio processing neural network (e.g., a speech recognition neural network) configured to perform an audio processing task, such as transcription, summarization, classification, speech recognition, translation, and so on.

When the model input 104 includes data for a particular data modality, the model input 104 can include sequences of input tokens representing the data for the particular data modality. For example, when the model input 104 includes text data, the model input 104 can include a sequence of text tokens representing the text of the model input 104. As another example, when the model input 104 includes image data, the model input 104 can include a sequence of image tokens representing the image. As another example, when the model input 104 includes a video, the model input 104 can include a sequence of video tokens representing the video. As another example, when the model input 104 includes audio, the model input 104 can include a sequence of audio tokens representing the audio of the model input 104.

The model input 104 can be an input prompt characterizing a request to perform a particular prediction task for input data included within the model input 104. In response to the request of the input prompt, the target machine learning model 102 can generate the uncalibrated output 106 by processing the model input 104 to perform the requested prediction task.

The confidence score 110 for the model output 108 can characterize a likelihood that the model output 108 is a correct output for the prediction task performed by the target machine learning model 102 when processing the model input 104 (e.g., when the model input 104 is an input prompt, the confidence score 110 can characterize a likelihood that the model output 108 represents a correct response to the input prompt). For example, when the target machine learning model 102 performs a regression task to predict one or more numerical values, the confidence score 110 can characterize, e.g., a predicted error of the predicted numerical values, a predicted probability that the predicted values are within a predetermined threshold distance of the truc values, and so on. As another example, when the target machine learning model 102 performs a classification task (e.g., a multi-class classification task in which the model 102 determines a respective probability for each of a plurality of classes and assigns the class having the highest probability as the class for the model input 104), the confidence score 110 can be the probability for the class assigned by the target machine learning model 102 to the model input 104. As another example, when the target machine learning model 102 performs a generation task (e.g., by determining an output distribution by processing the model input 104 and generating the model output 108 according to the output distribution), the confidence score can characterize a likelihood of the target machine learning model 102 generating the model output 108 (e.g., the likelihood of the model 102 sampling the model output 108 from the output distribution).

The target machine learning model 102 can be configured to generate the confidence score 110 by any appropriate method. As one example, the target machine learning model 102 can generate the confidence score 110 using a same network output layer that the model 102 uses to generate the model output 108. As another example, the target machine learning model 102 can generate the confidence score 110 and the model output 108 using separate sub-networks (e.g., sequences of neural network processing layers).

After the confidence calibration system 100 generates the calibrated output 112, the calibrated confidence score 114 can be used (e.g., by another system, by a user, etc.) as part of performing a variety of tasks. In particular, the calibrated confidence score 114 can be used to perform a variety of decision tasks regarding the model output 108 and the target machine learning model 102. In some implementations, the confidence calibration system 100 can determine a decision output 122 for a decision task using the calibrated confidence score 114 and can include the decision output 122 within the calibrated output 112. A few example decision tasks that can be performed using the calibrated confidence score 114 are described below.

As one example, the decision task can be an accept/reject decision to decide whether to accept or to reject the model output 108 based on the calibrated confidence score 114. For example, the confidence calibration system 100 can decide to reject the model output 108 when the calibrated confidence score 114 falls below confidence threshold for the decision task and the decision output 122 can indicate the accept/reject decision made by the system 100. Selecting a confidence threshold for the accept/reject decision is described in more detail below with reference to FIG. 3.

The system 100 can evaluate the accept/reject decision using the confidence score 110, e.g., by deciding to reject the model output 108 when the confidence score 110 falls outside a region determined by and corresponding to the certain confidence threshold for the calibrated confidence score 114 (e.g., as determined a confidence threshold for the confidence score 110).

The system 100 can perform any of a variety of actions if the system 100 decides to reject the model output 108. As an example, the system 100 can withhold outputting the model output 108. As another example, the system 100 can request validation of the model output 108 by a user of the system 100 (e.g., including the request within the decision output 122). As another example, the system 100 can provide the model input 104 to a different machine learning model for follow-up processing.

As another example, the decision task can be to decide whether to fine-tune the target machine learning model 102 based on the calibrated confidence score 114. For example, the confidence calibration system 100 can decide to fine-tune the target model 102 if the calibrated confidence score 114 falls below a confidence threshold for the decision task and the decision output 122 can indicate the retraining decision made by the system 100. As another example, the confidence calibration system 100 can decide to fine-tune the target model 102 if an average calibrated confidence score 114 (e.g., an average for a user of the system 100, an average for a processing task, etc.) falls below confidence threshold for the decision task and the decision output 122 can indicate the retraining decision made by the system 100. In some implementations, the system 100 itself can fine-tune the model 102 after deciding to fine-tune the model 102. For example, when an average of the calibrated confidence score 114 falls below the confidence threshold (e.g., indicating that the model output 108 is likely to be an unsatisfactory output for the model input 104), the system 100 can decide to fine-tune the model 102 to improve performance on model inputs similar to the model input 104. In some implementations, the system 100 can decide to fine-tune the model 102 based on the precision curve 118. For example, when the precision curve 118 indicates that the confidence score 110 inaccurately predicts the precision of the model 102 for the model input 104, the system 100 can decide to fine-tune the model 102 to improve the accuracy of the uncalibrated confidence scores generated by the model 102. When the system 100 decides to fine-tune the model 102, the system 100 can fine-tune the model 102 using training data that includes example inputs similar to the model input 104. For example, the system 100 can select or weight examples from a set of training examples based on a similarity of the training examples to model inputs received by the system (e.g., including the model input 104, model inputs received prior to or alongside the model input 104, and so on).

FIG. 2 illustrates training a calibration model 120 for a target machine learning model 102. The confidence calibration system 100 can train the calibration model 120 on a set of training data for the calibration model 120 using a training system 202.

The system 100 can generate a set of training data for the calibration model 120 using a set of example model inputs 204. The set of training data for the calibration model 120 can include a plurality of training examples for the model 120. Each training example can include one or more example model inputs for the training example from the set of example model inputs 204. For each example model input for a training example, the training example can include an example confidence threshold for the example model input and a ground truth precision of the target machine learning model 102 for the confidence threshold of the example model input. The ground truth precision for each example model input can be generated based on a ground truth precision curve for the example model inputs.

Each training example for the calibration model 120 can be associated with a particular application distribution (e.g., an application distribution assigned to the training example from a plurality of application distributions) for the training example. The example model input for each training example can be selected (e.g., sampled) from the application distribution for the training example. The system 100 can determine the ground truth precision curve for each of the training examples based on the precision of model outputs generated by the target machine learning model 102 by processing model inputs selected from the application distribution for the training example. Similarly, for each training example, the system 100 can process each example model input for the training example using the target machine learning model 102 and can determine the confidence threshold for the example model input using the confidence score generated by the target machine learning model 102 for the resulting model output for the example model input.

In general, each of the plurality of application distributions can represent a slice (e.g., a subset, segment, etc.) of a set of model inputs for the target machine learning model 102. For example, each application distribution can characterize a respective class or category of model inputs for the target machine learning model 102. As another example, when the target machine learning model 102 is configured to perform a plurality of prediction tasks, each application distribution can characterize a distribution of model inputs for a respective prediction task from the plurality of prediction tasks. As another example, when the model inputs represent input prompts received from a plurality of users, each application distribution can characterize a distribution of model inputs for a respective user from the plurality of users.

To train the calibration model 120 using a training example for the model 120, the confidence calibration system 100 can process each of the example model inputs for the training example using the target machine learning model 102 to generate an example confidence score 110 for the example model input. For each example model input, the training system 202 can determine a predicted precision for an example confidence threshold (e.g., the example confidence score) for the model input using a precision curve parameterized by the calibration model 120 for the training example. In some implementations, for each training example the calibration model 120 can receive and process the model inputs for the training example as part of determining the precision curve for the training example. The training system 202 can train the calibration model 120 using an objective function that, for each training example, measures a difference between (i) the precisions assigned by the calibration model 120 for the example confidence thresholds of the training example and (ii) the ground truth precisions for the example confidence thresholds of the training example as determined by the ground truth precision curve for the training example.

The training system 202 can use any appropriate machine learning technique to train the calibration model 120 using the objective function. In particular, the training system 202 can determine gradients of the objective function and can update parameters of the calibration model 120 following backpropagation of the gradients of the objective function. Training the calibration model 120 using the training system 202 is described in more detail below with reference to FIG. 4.

As described above, in some implementations, the confidence calibration system 100 can decide to fine-tune the target machine learning model 102. The system 100 can fine-tune the target machine learning model 102 on the set of example model inputs 204 for the calibration model 120 using the training system 202. In particular, when the system 100 decides to fine-tune the target machine learning model 102, the system 100 can process training examples from the set of model inputs 204 using the model 102 to generate model outputs and confidence scores for the model inputs of the training examples. The training system 202 can then fine-tune the target machine learning model 102 using an objective function for the model 102 (e.g., by backpropagating gradients of the objective function for the model 102 to update parameters of the model 102) that depends on the model outputs, the confidence scores, or both. As an example, the objective function for the model 102 can measure an error of the model outputs generated by the target machine learning model 102. As another example, the objective function for the model 102 can measure a difference between the confidence scores generated by the target machine learning model 102 and corresponding calibrated confidence scores generated using the calibration system 120.

FIG. 3 is a flow diagram of an example process 300 for performing confidence calibration for a target machine learning model. For convenience, the process 300 will be described as being performed by a system of one or more computers located in one or more locations. For example, a confidence calibration system, e.g., the confidence calibration system 100 of FIG. 1, appropriately programmed in accordance with this specification, can perform the process 300.

As described above with reference to FIG. 1, the target machine learning model can be configured to process model inputs (i) to produce corresponding model outputs for the model inputs and (ii) to assign corresponding initial confidence scores to the produced outputs. The model inputs can include data for any of a variety of data modalities, e.g., numerical data, text data, image data, video data, audio data, and so on. The target machine learning model can be any appropriate machine learning model configured to process the model inputs. The target machine learning model can include, e.g., a support vector machine, a random forest model, a regression model, a neural network, and so on, configured to process the model input. In particular, the target machine learning model can include a neural network with any appropriate neural network architecture with processing layers (e.g., multi-layer perceptron layers, convolutional layers, recurrent layers, graph processing layers, attention layers, etc.) in any arrangement appropriate for processing the model input. In some implementations, the model input can include a sequence of input tokens and the target machine learning model can be a token processing neural network. For example, the target machine learning model can be a language model, a visual language model, and so on. In some implementations, the model inputs can be input prompts from users and the target machine learning model can be configured to generate the model outputs and initial confidence estimates as responses to the input prompts.

The target machine learning model can be configured to perform any of a variety of prediction tasks. For example, the target machine learning model can be configured to perform, e.g., a regression task, a classification task, a generation task, and so on. As further examples, the target machine learning model can be configured to perform, e.g., a language processing task, an image processing task, a video processing task, an audio processing task, a speech recognition task, and so on. In some implementations, the target machine learning model can be configured to perform a plurality of prediction tasks and can process each model input to perform a particular processing task for the model input (e.g., as specified by the model input).

The target machine learning model can be configured to generate the initial confidence scores by any appropriate method. As one example, the target machine learning model can generate the initial confidence scores using a same network output layer that the target machine learning model uses to generate the model outputs. As another example, the target machine learning model can generate the initial confidence scores and the model outputs using separate sub-networks (e.g., sequences of neural network processing layers).

The confidence calibration system can perform confidence calibration for the target machine learning model following steps 302-310.

In some implementations, the system can receive conditioning data for a calibration model for the target machine learning model (step 302). As an example, the conditioning data can include one or more query inputs for the target machine learning model that characterize an application distribution (e.g., “slice”) of model inputs. For example, the query inputs can be model inputs received by the system from a user.

The system can generate precision data that specifies a precision curve for the target machine learning model using a calibration model for the target machine learning model (step 304).

For each initial confidence score, c, generated by the target machine learning model, the precision curve for the target machine learning model, PC (c), specifies the percentage of model outputs generated by the target machine learning model assigned confidence scores greater than the confidence score threshold c that are correct (e.g., as determined in reference to ground truth outputs or labels).

As described above with reference to FIG. 1, the calibration model can be any appropriate machine learning model configured to generate the precision data characterizing the precision curve for the target machine learning model. In particular, when the system receives conditioning data, the calibration model can be any appropriate machine learning model configured to process the conditioning data. The calibration model can, for example, include a neural network with any appropriate neural network architecture with processing layers (e.g., multi-layer perceptron layers, convolutional layers, recurrent layers, graph processing layers, attention layers, etc.) in any arrangement appropriate for processing the conditioning data. In some implementations, when the conditioning data includes a sequence of input tokens, the calibration model can be a token processing neural network. For example, the calibration model can be a language model, a visual language model, and so on.

When the system receives conditioning data for the calibration model that includes query inputs, the system can process the query inputs to generate precision data specifying a precision curve for the target machine learning model as applied to a distribution of model inputs characterized by the query inputs. For example, when the calibration model is a token processing neural network, the system can generate a combined sequence of tokens representing the query inputs and can process the combined sequence of tokens using the calibration model to generate the precision data.

The system can receive a model input for the target machine learning model (step 306). When the system receives query inputs that include model inputs from a user, the received model inputs can be a new, subsequence input received from the same user after the query inputs.

The system can process the received model input using the target machine learning model to generate a predicted model output for the received model input and to assign an initial confidence score to the predicted model output (step 308).

The system can generate a final output for the received model input using the initial confidence score and the precision data for the target machine learning model (step 310). The system can determine a calibrated confidence score for the model output and include the calibrated confidence score within the final output. For example, the system can generate a confidence calibration function that maps initial confidence scores to calibrated confidence scores (e.g., predicted model accuracies) based on the precision data from the calibration model and can assign a calibrated confidence score to the model output by processing the initial confidence score using the confidence calibration function.

For example, the confidence calibration function can be determined by binning the precision curve generated by the calibration model. For bin Bᵢ, bounded by initial confidence thresholds cy and C, the confidence calibration function can map initial confidence scores, cₗ≤C<cᵣ, to the calibrated confidence score c′ (c) following:

$${c}^{′} ( c ) = \frac{p ( {c}_{l} ) f ( {c}_{l} ) - p ( {c}_{r} ) f ( {c}_{r} )}{f ( {c}_{l} ) - f ( {c}_{r} )}$$

Where p(cₗ) is the precision of the target machine learning model at the initial confidence threshold cₗ, p(cᵣ) is the precision of the target machine learning model at the initial confidence threshold cᵣ, f(cₗ) is the fraction of model outputs assigned initial confidence scores greater than the initial confidence threshold cₗ, and f(cᵣ) is the fraction of model outputs assigned initial confidence scores greater than the initial confidence threshold cᵣ.

In some implementations, the system can evaluate decisions for the model output and the target machine learning model based on the calibrated confidence score and can include the resulting decisions within the final output. As an example, the system can evaluate an accept/reject decision of whether to accept or to reject the predicted model output for the received input, based on whether the initial confidence score assigned to the predicted model output falls below a particular confidence threshold.

The system can perform any of a variety of actions if the system decides to reject the model output. As an example, the system can withhold outputting the model output. As another example, the system can request validation of the model output by a user of the system. As another example, the system can provide the model input to a different machine learning model for follow-up processing.

In some implementations, the system can obtain data specifying a target precision for the target machine learning model and can determine, based on the precision data, the particular confidence threshold for which the target machine learning model attains the target precision. In particular, the system can determine a target precision that optimizes a utility function specifying respective utility costs for accepting and rejecting outputs from the target machine learning model.

In some implementations, the system can determine, based on the precision data, whether to fine-tune the target machine learning model. For example, the confidence calibration system can decide to retrain the target machine learning model when the calibrated confidence score falls below a particular confidence threshold for the decision task. As another example, the confidence calibration system can decide to retrain the target machine learning model when an average of the calibrated confidence score falls below a particular confidence threshold for the decision task. As another example, when the precision curve indicates that the confidence score inaccurately predicts the precision of the target machine learning model for the received model input, the system can decide to retrain the target machine learning model to improve the accuracy of the uncalibrated initial confidence scores generated by the model.

In some implementations, the system itself can fine-tune the model after deciding to retrain the target machine learning model, as described in more detail above with reference to FIG. 2. When the system decides to fine-tune the model, the system can fine-tune the model using training data that includes example model inputs similar to the received model input. For example, the system can select or weight training examples from a set of training examples based on a similarity of the training examples to model inputs received by the system (e.g., including the received model input, query inputs included within conditioning data for the calibration model, and so on).

FIG. 4 is a flow diagram of an example process 400 for training a confidence model for a target neural network. For convenience, the process 400 will be described as being performed by a system of one or more computers located in one or more locations. For example, a confidence calibration system, e.g., the confidence calibration system 100 of FIG. 1, appropriately programmed in accordance with this specification, can perform the process 400.

The system can obtain training data for the calibration model that includes a plurality of training examples (step 402). Each training example can include (i) one or more example model inputs for the training example, (ii) one or more example confidence thresholds for the training example, and (iii) ground truth precisions of the target machine learning model for each of the example confidence thresholds determined by a ground truth precision curve for the training example.

The model inputs for each training example can be selected (e.g., sampled) from an application distribution (e.g., “slice”) for the training example. As an example, the training examples can be selected from a set of training data that includes N separate application distributions for the training data. The application distribution for each training distribution can be determined as a mixture distribution of the N application distributions for the training data. For example, the application distribution for a training example, p can be determined following:

$$p = {\sum }_{i = 1}^{m} {α}_{i} {p}_{i}$$

Where m is a random number between 1 and N (e.g., as sampled from a geometric distribution), P₁, . . . , Pₘ are m application distributions selected randomly from the N application distributions for the training data, and a₁, . . . , aₘ are randomly selected mixture coefficients (e.g., as sampled using a mixture distribution of order m.

The system can process the training examples using the calibration model to generate precision data characterizing a predicted precision curve for each training example (step 404). When the calibration model is configured to generate the precision data by processing conditioning data that includes query inputs, the calibration model can generate the predicted precision curves for the training examples by processing the model inputs for the training examples as query inputs.

The system can update the calibration model to optimize an objective function that measures a difference between the example precision curves and ground truth precision curves for the training example (step 406). In particular, for each training example, the objective function can measure a difference between (i) a precision assigned by the calibration model for an example confidence threshold in the training example following the predicted precision curve and (ii) the ground truth precision for the example confidence threshold for the training example following the predicted precision curve for the training example.

In some implementations, the objective function increases a loss (e.g., a penalty) for the calibration model when the calibration model assigns a higher precision for a given confidence threshold than the ground truth precision. For example, the objective function can be:

[symbol]

= [symbol] _{c∈c}_{₁}_{, . . . ,c}_{ₙ}[ [symbol] (\hat{p},p*,c)]

Where c₁, . . . , cₙ is a sequence of confidence thresholds, \hat{p} denotes predicted precision curve, p* denotes the ground truth precision curve, and [symbol] (\hat{p}, p*, c) is an asymmetric loss defined following:

$$ℒ ( \hat{p} , {p}^{*} , c ) = \{ \begin{matrix}β {‖ \hat{p} ( c ) - {p}^{*} ( c ) ‖}^{2} , if \hat{p} ( c ) > {p}^{*} ( c ) \\ {‖ \hat{p} ( c ) - {p}^{*} ( c ) ‖}^{2} , otherwise\end{matrix}$$

Where β is a penalty coefficient. By utilizing the asymmetric loss, to train the calibration model, the system can encourage the calibration model to avoid overestimation or underestimation of the precision of the target machine learning model. For example, setting the penalty coefficient β>1.0, the system can penalize overconfidence (e.g., overestimating the precision of the target machine learning model for a confidence threshold) more than underestimation (e.g., underestimating the precision of the target machine learning model for a confidence threshold).

The system can finally return the trained calibration model (step 408).

FIG. 5A illustrates calibration curves for a target machine learning model that is miscalibrated on particular distributions of model inputs. Each calibration curve the accuracy of the target machine learning model with respect to initial confidence scores for a respective distribution (e.g., application distribution) of model inputs.

FIG. 5A illustrates an aggregate calibration curve 502 for the target machine learning model for an aggregate distribution of model inputs that includes multiple application distributions (e.g., “slices”). As illustrated, the aggregate calibration curve 502 indicates that the target machine learning model is well calibrated, on average, for the aggregate distribution of model inputs.

However, the target machine learning model can remain miss-calibrated for individual application distributions within the aggregate distributions. For example, the calibration curves 504-A and 504-B illustrate that the target machine learning model is miss-calibrated for respective application distributions. In particular, the calibration curve 504-A indicates that the target machine learning model can be significantly under-confident for the application distribution of 504-A. The calibration curve 504-B indicates that the target machine learning model can be significantly over-confident for the application distribution of 504-B.

By performing few-shot recalibration of the target machine learning model using unlabeled model inputs, the described systems can recalibrate the target machine learning model for arbitrary application distributions, without using any labeled data from the application distribution (e.g., without knowing the identity of the application distribution).

FIG. 5B illustrates experimental results from using a confidence calibration system to recalibrate a target machine learning model that is miscalibrated on a particular application distribution of model inputs.

FIG. 5B illustrates precision curves for a target machine learning model as recalibrated using an few-shot recalibration 506 with an implementation of the systems described in this specification and as recalibrated using conventional methods for model recalibration 508 in comparison with a ground truth precision curve 510 for the target machine learning model as applied to the application distribution. As illustrated by FIG. 5B, the systems described by this specification can perform few-shot recalibration of machine learning models to recover more accurate precision curves (e.g., more accurate confidence estimates) as compared to conventional methods for model calibration.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving a plurality of query inputs to a target machine learning model, wherein the target machine learning model is configured to process model inputs (i) to produce corresponding model outputs for the model inputs and (ii) to assign corresponding initial confidence scores to the produced outputs;
processing the query inputs using a calibration model to generate precision data for the target machine learning model that specifies a precision curve, wherein:
the precision curve maps confidence thresholds to precisions,
each confidence threshold is a threshold on initial confidence scores generated by the target machine learning model, and
a precision for a given confidence threshold is a precision of model outputs generated by the target machine learning model that have initial confidence scores attaining the given confidence threshold;
receiving a new input for the target machine learning model;
processing the new input using the target machine learning model to generate a predicted model output for the new input and to assign an initial confidence score to the predicted model output; and
generating a final output for the new input using the initial confidence score and the precision data for the target machine learning model.

2. The method of claim 1, wherein the final output indicates a decision of whether to reject the predicted model output for the new input or accept the predicted model output for the new input, based on whether the initial confidence assigned to the predicted model output score falls below a particular confidence threshold.

3. The method of claim 2, further comprising:
obtaining data specifying a target precision for the target machine learning model; and
determining, based on the precision data, the particular confidence threshold for which the target machine learning model attains the target precision.

4. The method of claim 3, wherein obtaining data specifying a target precision comprises:
determining, in accordance with the prediction data, a target precision that optimizes a utility function specifying respective utility costs for accepting a correct output from the target machine learning model, accepting an incorrect output from the target machine learning model, and rejecting an output generated by the machine learning model.

5. The method of claim 1, further comprising:
generating a confidence calibration function that maps initial confidence scores to calibrated confidence scores based on the precision data, wherein:
generating a final output comprises assigning a calibrated confidence score to the predicted model output for the new input by processing the initial confidence score assigned to the predicted model output using the confidence calibration function.

6. The method of claim 1, wherein:
the target machine learning model is configured to perform multi-class classification,
the target machine learning model is configured to process a given model input to produce respective probabilities of the given model input belonging to each of a plurality of classes;
the model output for the given model input identifies a class having a largest probability, and
the initial confidence score assigned to the model output is the largest probability.

7. The method of claim 1, wherein the target machine learning model is configured:
to produce model outputs according to output distributions determined by processing the corresponding model inputs; and
to assign confidence scores to the model outputs characterizing the likelihood of sampling the model outputs from the corresponding output distributions.

8. The method of claim 1, wherein the query inputs and the new input are respective sequences of tokens.

9. The method of claim 8, wherein the calibration model is configured to process a sequence of tokens to generate the precision data and wherein processing the query inputs to generate precision data for the target machine learning model that specifies a precision curve comprises:
generating a combined sequence of tokens from the respective token sequences of the query inputs;
processing the combined sequence using the calibration model; and
generating precision data specifying a precision curve for the target machine learning model as applied to a distribution of model inputs characterized by the query inputs.

10. The method of claim 9, wherein the calibration model includes a language model neural network.

11. The method of claim 1, wherein the target machine learning model is a language model neural network configured to perform a text processing task.

12. The method of claim 1, wherein the query inputs are a plurality of inputs to the target machine learning model received from a first user and the new input is a subsequent input to the target model received from the first user after the query inputs.

13. The method of claim 1, wherein the calibration model has been trained on a set of training data that comprises a plurality of training examples, each training example comprising:
(i) one or more example model inputs,
(ii) one or more example confidence thresholds, and
(iii) ground truth precisions of the target machine learning model for each of the example confidence thresholds and generated based on a ground truth precision curve for the example model inputs.

14. The method of claim 13, wherein the calibration model has been trained using an objective function that, for each training example, measures a difference between (i) a precision assigned by the calibration model for an example confidence threshold in the training example by processing the one or more example model inputs in the training example and (ii) the ground truth precision for the example confidence threshold for the training example.

15. The method of claim 14, wherein the objective function increases the loss when the calibration model assigns a higher precision for a given confidence threshold than the ground truth precision.

16. The method of claim 13, wherein, for each training example:
the example model inputs are selected from a particular application distribution, assigned to the training example from a plurality of application distributions; and
the ground truth precision curve for the example model inputs is determined based on the precisions achieved by the target machine learning model as applied to model inputs selected from the particular application distribution.

17. The method of claim 1, further comprising:
determining, based on the precision data, to fine-tune the target machine learning model; and
fine-tuning the target machine learning model.

18. The method of claim 17, wherein fine-tuning the target machine learning model comprises:
fine-tuning the target machine learning model on training data that is selected or that is weighted using the query inputs.

19. One or more non-transitory computer storage media storing instructions that when executed by one or more computers cause the one or more computers to perform operations comprising:
receiving a plurality of query inputs to a target machine learning model, wherein the target machine learning model is configured to process model inputs (i) to produce corresponding model outputs for the model inputs and (ii) to assign corresponding initial confidence scores to the produced outputs;
processing the query inputs using a calibration model to generate precision data for the target machine learning model that specifies a precision curve, wherein:
the precision curve maps confidence thresholds to precisions,
each confidence threshold is a threshold on initial confidence scores generated by the target machine learning model, and
a precision for a given confidence threshold is a precision of model outputs generated by the target machine learning model that have initial confidence scores attaining the given confidence threshold;
receiving a new input for the target machine learning model;
processing the new input using the target machine learning model to generate a predicted model output for the new input and to assign an initial confidence score to the predicted model output; and
generating a final output for the new input using the initial confidence score and the precision data for the target machine learning model.

20. A system comprising:
one or more computers; and
one or more storage devices communicatively coupled to the one or more computers, wherein the one or more storage devices store instructions that, when executed by the one or more computers, cause the one or more computers to perform operations comprising:
receiving a plurality of query inputs to a target machine learning model, wherein the target machine learning model is configured to process model inputs (i) to produce corresponding model outputs for the model inputs and (ii) to assign corresponding initial confidence scores to the produced outputs;
processing the query inputs using a calibration model to generate precision data for the target machine learning model that specifies a precision curve, wherein:
the precision curve maps confidence thresholds to precisions,
each confidence threshold is a threshold on initial confidence scores generated by the target machine learning model, and
a precision for a given confidence threshold is a precision of model outputs generated by the target machine learning model that have initial confidence scores attaining the given confidence threshold;
receiving a new input for the target machine learning model;
processing the new input using the target machine learning model to generate a predicted model output for the new input and to assign an initial confidence score to the predicted model output; and
generating a final output for the new input using the initial confidence score and the precision data for the target machine learning model.
